(19) United States
(12) Patent Application Publication
(10) Pub. No.: US 2012/0245030 A1
(43) Pub. Date: Sep. 27, 2012

(54) HERBICIDE COMPOSITION

(76) Inventors: Tadaji Iwata, Takarazuka-shi (JP); Naoki Tsuda, Takarazuka-shi (JP)

(21) Appl. No.: 13/426,181

(22) Filed: Mar. 21, 2012

(30) Foreign Application Priority Data
Mar. 22, 2011 (JP) 2011-062076

(51) Int. Cl. A01N 43/84; A01P 13/00

(52) U.S. Cl. 504/224

(57) ABSTRACT

The invention provides a herbicide composition having a remarkable effect on controlling weeds which comprises N-(7-fluoro-3,4-dihydro-3-oxo-4-prop-2-ynyl-2H-1,4-benzoxazin-6-yl)cyclohex-1-ene-1,2-dicarboxamide and an inert carrier, wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 1.7 μm or less.

### TECHNICAL FIELD

The invention relates to a herbicide composition and a method for controlling weeds.

### BACKGROUND ART

Previously, many kinds of herbicides have been developed and have been in practical use.

N-(7-Fluoro-3,4-dihydro-3-oxo-4-prop-2-ynyl-2H-1,4-benzoxazin-6-yl)cyclohex-1-ene-1,2-dicarboxamide is known as an active ingredient of a herbicide (see, for example, Non-patent reference 1).
Non-patent reference 1: Crop Protection Handbook, Vol. 89 (2003), page C236 (Meister Publishing Company, ISBN:1-892829-06-1)

### SUMMARY OF INVENTION

### Technical Problem

The object of the present invention is to provide a herbicide composition having a remarkable effect on controlling weeds.

### Solution to Problem

The present inventors have extensively studied to find out herbicide compositions having a remarkable effect on controlling weeds and then have found that N-(7-fluoro-3,4-dihydro-3-oxo-4-prop-2-ynyl-2H-1,4-benzoxazin-6-yl)cyclohex-1-ene-1,2-dicarboxamide having a specific volume median diameter has a remarkable effect on controlling weeds, and thereby have completed the present invention.

That is, the present invention provides the following aspects.

[1] A herbicide composition comprising N-(7-fluoro-3,4-dihydro-3-oxo-4-prop-2-ynyl-2H-1,4-benzoxazin-6-yl)cyclohex-1-ene-1,2-dicarboxamide and an inert carrier, wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 1.7 μm or less.
[2] The herbicide composition according to [1] wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 0.1 μm to 1.7 μm.
[3] The herbicide composition according to [1] wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 0.2 μm to 1.7 μm.
[4] The herbicide composition according to [1] wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 0.25 μm to 1.7 μm.
[5] A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 1.7 μm or less to weeds or a soil on which weeds grow.
[6] A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 0.1 μm to 1.7 μm to weeds or a soil on which weeds grow.
[7] A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 0.2 μm to 1.7 μm to weeds or a soil on which weeds grow.
[8] A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 0.25 μm to 1.7 μm to weeds or a soil on which weeds grow.

### Effects of Invention

The present invention may control weeds effectively.

### DESCRIPTION OF EMBODIMENTS

The herbicide composition of the present invention may be a herbicide composition comprising N-(7-fluoro-3,4-dihydro-3-oxo-4-prop-2-ynyl-2H-1,4-benzoxazin-6-yl)cyclohex-1-ene-1,2-dicarboxamide and an inert carrier wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 1.7 μm or less (hereinafter, referred to as the present composition).

N-(7-Fluoro-3,4-dihydro-3-oxo-4-prop-2-ynyl-2H-1,4-benzoxazin-6-yl)cyclohex-1-ene-1,2-dicarboxamide comprised in the present composition is a compound having a herbicidal activity and is generally known by the name of flumioxazin (hereinafter, referred to as “flumioxazin”). Flumioxazin is described, for example in Crop Protection Handbook, Vol. 89 (2003), page C236 (Meister Publishing Company, ISBN:1-892829-06-1).

Flumioxazin used in the present invention has a volume median diameter of 1.7 μm or less, for example, 0.1 μm to 1.7 μm, 0.2 μm to 1.7 μm, and 0.25 μm to 1.5 μm. Flumioxazin having such volume median diameter may be prepared, for example, by wet-milling which comprises stirring a slurry of flumioxazin with glass beads which are a tiny sphere at high speed to grind flumioxazin.

The present composition may be used as a formulation such as a wettable powder, a suspension, a granule and the like, which comprises flumioxazin having a volume median diameter of 1.7 μm or less and an inert carrier such as a solid carrier and a liquid carrier and the like and optionally comprises a surfactant, other additives.

The flumioxazin having a volume median diameter of 1.7 μm or less in the present composition is contained generally in an amount of 0.1 to 70% by weight, preferably to 60% by weight per the total weight of the present composition.

The “volume median diameter” of flumioxazin as used herein refers to a value obtained by analyzing an image of many particles observed by the method of laser diffraction scattering based on the theory of Mie Scattering. A measuring instrument for the volume median diameter includes, for example, Mastersizer 2000 (Malvern), SALD-2200 (Shimadzu), Microtrac MT3000 (Nikkiso) and the like.

The particle size distribution obtained by such measuring instruments is a particle size distribution on a volume basis on the assumption that the measured particles are spherical. A volume median diameter (VMD) as used herein is a diameter wherein each total volume of the particles having a larger or smaller diameter than the VMD is each 50% per the total volume of the measured particles.

The inert carrier which may be used in the present composition includes, for example, a powdered or granulated solid carrier such as clays (kaolinite, diatom earth, synthetic silicon oxide hydrate, Fubasami clay, bentonite, acid earth and the like), talc, other inorganic minerals (sericite, quartz powder, sulfur powder, active carbon, calcium carbonate and the like), chemical fertilizer (ammonium sulfate, ammonium phosphate, ammonium nitrate, ammonium chloride, urea and the like), and a liquid carrier such as water and the like.

The inert carrier may be contained generally in an amount of 0.01 to 50% by weight, preferably 0.1 to 30% by weight based on the total weight of the present composition.

The surfactant includes, for example, alkylsulfate esters, alkylsulfonate, alkylarylsulforiate, alkylarylethers and a polyoxyethylene compound thereof, polyethylene glycol ethers, polyhydric alcohol esters, sugar alcohol derivative and the like. Other additive includes, for example, a sticking agent/dispersing agent such as casein, gelatin, polysaccharides (starch, acacia, cellulose derivative, alginic acid and the like), lignin derivative, bentonite, synthetic water-soluble polymer (polyvinyl alcohol, polyvinylpyrrolidone, polyacrylic acid etc.) and the like, and a stabilizing agent such as PAP (isopropyl acid phosphate), BHT (2,6-tert-butyl-4-methylphenol), BHA (2-/3-tert-butyl-4-methoxyphenol), vegetable oil, mineral oil, fatty acid, fatty acid ester and the like.

The present composition formulated as above may be used as a spraying agent without dilution or after diluting with water or other solvents to control weeds.

The method for controlling weeds of the present invention may comprise applying flumioxazin having a volume median diameter of 1.7 μm or less to weeds or a soil on which weeds grow. The method for controlling weeds of the present invention may be generally carried out by applying the present composition as described above without dilution or after diluting with water or other solvents to weeds or a soil on which weeds grow.

In the method for controlling weeds of the present invention, the amount of the applied flumioxazin having a volume median diameter of 1.7 μm or less may be decided depending on weather, formulation, season, method of application, the kind of weeds, the kind of crop and the like. Specifically, the amount of application may be 10-1000 g per 10000 m² of a soil on which weeds grow. When the present composition is a wettable powder or a suspension etc., the given amount of the applied flumioxazin having a volume median diameter of 1.7 μm or less may be generally applied after diluting with 50 to 3000 L of water per 10000 m² of a soil on which weeds grow.

When flumioxazin having a volume median diameter of 1.7 μm or less is applied to foliage of weeds, an adjuvant may be added to the present composition diluted with water to enhance the efficacy of controlling weeds.

The soil on which the method of the present invention is used for controlling weeds includes, for example, an agricultural land, an orchard and a non-agricultural land.

The agricultural land as used herein includes, for example, a land on which a crop such as soy, corn, wheat, barley and the like grows.

The orchard as used herein includes, for example, a fruit farm where a fruit tree such as apple, Japanese pear, pear, peach, prune, nectarine, Japanese plum, cherry, chestnut, persimmon, ficus, grape, loquat and citrus and the like grows, tea field, mulberry field, coffee field, banana field, palm field, flowering trees garden, flowering trees field, nursery, nursery plant, forest land and garden.

Such crop, fruit, etc, may be a genetically-engineered plant.

The non-agricultural land as used herein includes, for example, playfield, empty lot, the end of rail track, park, parking lot, the end of road, location of river, land under an electric feeder line, building land and factory site.

The present composition may be used as a mixture with or in combination with other herbicide, and/or insecticide, miticide, nematicide, fungicide, plant growth regulator, safener, fertilizer, soil conditioner and the like.

The active ingredient of said other herbicide, insecticide, miticide, nematicide, fungicide, plant growth regulator, safener, fertilizer, soil conditioner and the like which the present composition may be used as a mixture with or in combination with includes, for example,

insecticide (an ingredient having an insecticidal activity): fenthion, fenitrothion, pirimiphos-methyl, diazinon, guinalphos, isoxathion, pyridafenthion, chlorpyrifos-methyl, vamidothion, malathion, phenthoate, dimethoate, disulfoton, monocrotophos, tetrachlorvinphos, chlorfenvinphos, propaphos, acephate, trichlorphon, EPN, pyraclorfos, carbaryl, metolcarb, isoprocarb, SPMC, propoxur, XMC, carbofuran, carbosulfan, benfuracarb, furathiocarb, methomyl, thiodicarb, cycloprothrin, ethofenprox, cartap, bensultap, thiocyclam, buprofezin, tebufenozide, ethiprole, pyridalyl, clothianidin, dinotefuran, imidacloprid, thiamethoxam, acetamiprid, nitenpyram, thiacloprid, an agriculturally acceptable salt thereof and the like;

miticide (an ingredient having miticidal activity): hexythiazox, pyridaben, fenpyroximate, tebufenpyrad, chlorfenapyr, etoxazole, pyrimidifen, spirodiclofen, an agriculturally acceptable salt thereof and the like;

nematicide (an ingredient having nematicidal activity): fosthiazate and an agriculturally acceptable salt thereof and the like;

fungicide (an ingredient having fungicidal activity): captan, IBP, EDDP, tolclofos-methyl, benomyl, carbendazim, thiophanate-methyl, mepronil, flutolanil, thifluzamid, furametpyr, teclofthalam, pencycuron, carpropamid, diclocymet, metalaxyl, triflumizole, azaconazole, bromuconazole, cyproconazole, diclobutrazol, difenoconazole, diniconazole, diniconazole-M, epoxiconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, pefurazoate, prochloraz, azoxystrobin, dimoxystrobin, fluoxastrobin, kresoxim-methyl, metominostrobin, orysastrobin, picoxystrobin, pyraclostrobin, trifloxystrobin, validamycin A,

blasticidin S, kasugamycin, polyoxin, fthalide, probenazole, isoprothiolane, tricyclazole, pyroquilon, ferimzone, acibnzolar S-methyl, diclomezine, oxolinic acid, phenazineoxide, TPN, iprodione, an agriculturally acceptable salt thereof and the like;

herbicide (an ingredient having herbicidal activity): 2,4-D, 2,4-DB, MCPA, MCPB, mecoprop, mecoprop-P, dichlorprop, dichlorprop-P, dicamba, dicamba diglycolamine salt, dicamba-dimethylammonium, dicamba-potassium, dicamba-sodium, bromoxynil, dichlobenil, ioxynil, di-allate, butylate, tri-allate, phenmedipham, chlorpropham, asulam, phenisopham, benthiocarb, molinate, esprocarb, pyributicarb, prosulfocarb, orbencarb, EPTC, dimepiperate, swep, propachlor, metazachlor, alachlor, acetochlor, metolachlor, S-metolachlor, butachlor, pretilachlor, thenylchlor, aminocyclopyrachlor, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, benzobicyclon, dithiopyr, triclopyr, thiazopyr, aminopyralid, clopyralid, dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, isoxaflutole, mesotrione, topramezone, pyrasulfotole, tembotrione, bicyclopyrone, sulcotrione, tefuryltrione, isoxachlortole, benzofenap, pyrazolynate, pyrazoxyfen, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazaquin, imazethapyr, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glyphosate, glyphosate-isopropylamine, glyphosate-trimethylsulfonium, glyphosate-ammonium, glyphosate-diammonium, glyphosate-sodium, glyphosate-potassium, glufosinate, glufosinate-ammonium, glufosinate-P, glufosinate-P-sodium, bialafos, anilofos, bensulide, butamifos, paraquat, diquat, an agriculturally acceptable salt thereof and the like;

plant growth regulator (an ingredient having plant growth regulation activity): hymexazol, paclobutrazol, uniconazole, uniconazole-P, inabenfide, prohexadione-calcium, 1-methylcyclopropene, trinexapac, gibberellins, and an agriculturally acceptable salt thereof and the like;

safener: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, an agriculturally acceptable salt thereof and the like.

The weeds which may be controlled by the method of the present invention include, for example:

Polygonaceae: Polygonum convolvulus, Polygonum lapathifolium, Polygonum pensylvanicum, Polygonum persicaria, Rumex crispus, Rumex obtusifolius, Polygonum cuspidatum;

Portulacaceae: Portulaca oleracea;

Caryophyllaceae: Stellaria media;

Chenopodiaceae: Chenopodium album, Kochia scoparia;

Amaranthaceae: Amaranthus retroflexus, Amaranthus hybridus;

Brassicaceae: Raphanus raphanistrum, Sinapis arvensis, Capsella bursa-pastoris;

Leguminosae: Sesbania exaltata, Cassia obtusifolia, Desmodium tortuosum, Trifolium repens;

Malvaceae: Abutilon theophrasti, Sida spinosa;

Violaceae: Viola arvensis, Viola tricolor;

Rubiaceae: Galium aparine;

Convolvulaceae: Ipomoea hederacea, Ipomoea purpurea, Ipomoea hederacea var integriuscula, Ipomoea lacunosa, Convolvulus arvensis);

Lamiaceae: Lamium purpureum, Lamium amplexicaule;

Solanaceae: Datura stramonium, Solanum nigrum;

Scrophulariaceae: Veronica persica, Veronica hederaefolia;

Asteraceae: Xanthium pensylvanicum, Helianthus annuus, Matricaria inodora, Chrysanthemum segetum, Matricaria matricarioides, Ambrosia artemisiifolia, Ambrosia trifida, Erigeron canadensis, Artemisia princeps, Solidago altissima;

Boraginaceae: Myosotis arvensis;

Asclepiadaceae: Asclepias syriaca;

Euphorbiaceae: Euphorbia helioscopia, Euphorbia maculata;

Poaceae: Echinochloa crus-galli, Setaria viridis, Setaria faberi, Digitaria sanguinalis, Eleusine indica, Poa annua, Alopecurus myosuroides, Avena fetua, Sorghum halepense, Agropyron repens, Bromus tectorum, Cynodone dactylon, Panicum dichotomiflorum, Panicum texanum, Sorghum vulgate, Lolium multiflorum;

Commelinaceae: Commelina communis, Commelina bengharensis;

Equisetaceae: Equisetum arvense; and

Cyperaceae: Cyperus iria, Cyperus rotundus, Cyperus esculentus.

### EXAMPLE

The following Formulation examples, Effect Tests and the like serve to illustrate the present invention more specifically, which do not intend to limit the present invention.

In this Example, the volume median diameter of flumioxazin is measured with Mastersizer 2000 laser diffraction particle size analyzer (Malvern).

In this Example, the term “parts” means “parts by weight”.

First, Formulation examples and Comparison examples are shown below.

### Formulation Example 1

100 parts of flumioxazin, 50 parts of ethoxylated tristyrylphenol phosphate potassium salt (Trade name: Soprophor FLK, Rhodia), 2 parts of a silicone antifoamer (Trade name: Antifoam C Emulsion, Dow corning), and 590 parts of ion-exchanged water were mixed, and the resulting mixture was wet-milled using a wet grinding mill (DYNO-MILL KD-L, Willy A. Bachofen) which is loaded with 1.0 mm-diameter glass beads to 80% of the chamber volume at the peripheral speed of 10 m/s with a dwell time of 3 min. to give a milled slurry comprising flumioxazin.

Then, to 200 parts of ion-exchanged water were added 50 parts of propylene glycol (ADEKA), 2 parts of xanthan gum (Trade name: KELZAN S, KELCO), 4 parts of magnesium aluminum silicate (Trade name: Veegum granules, R. T. Vanderbilt), and 2 parts of a preservative (Trade name: Proxel GXL, Arch Chemicals), and the mixture was stirred to give an aqueous thickener solution.

74.2 parts of the milled slurry and 25.8 parts of the aqueous thickener solution were mixed to give a formulation comprising flumioxazin. The flumioxazin had a volume median diameter of 1.4 μm.

### Formulation Example 2

500 g of the milled slurry prepared in Formulation example 1 with the addition of 400 g of 0.1 mm-diameter zirconia beads was wet-milled using a wetting disperser (Product name: Ultra Apex Mill UAM015, Kotobuki Industries) at a frequency of 50 Hz with a flow rate of 100 mL/min for 30 min. 74.2 parts of the resulting slurry and 25.8 parts of the aqueous thickener solution prepared in Formulation example 1 were mixed to give a formulation comprising flumioxazin. The flumioxazin had a volume median diameter of 0.27 μm.

### Comparison Example 1

10 parts of flumioxazin, 5 parts of ethoxylated tristyrylphenol phosphate potassium salt (Trade name: Soprophor FLK, Rhodia), 0.2 parts of a silicone antifoamer (Trade name: Antifoam C Emulsion, Dow corning), and 59 parts of ion-exchanged water were mixed. The resulting mixture was placed into a 500 mL SUS beaker, and 100 g of 1.5 mm-diameter glass beads was added thereto, followed by stirring the mixture with Laboratory Stirrer LR400D (Yamato Scientific) at a rotating speed of 1600 rpm for 2 min. Then the glass beads were removed to give a milled slurry comprising flumioxazin. 50 parts of the resulting slurry and 17.38 parts of the aqueous thickener solution prepared in Formulation example 1 were mixed to give a formulation comprising flumioxazin. The flumioxazin had a volume median diameter of 23.3 μm.

### Comparison Example 2

A formulation comprising flumioxazin of Comparison example 2 was prepared in a manner similar to Comparison example 1 with the exception of the stirring time of 10 min. The flumioxazin has a volume median diameter of 5.20 μm.

Effect Tests are shown below.

In the Effect Tests, the herbicidal effect is evaluated visually and rated on a score of 1 to 100, wherein “0” means that there was no or little difference in the degree of germination or growth between the treated weeds and the untreated weeds at the time of evaluation, and “100” means that the treated weeds died completely or their germination or growth was completely inhibited. The score from 70 to 100 means that the herbicidal effect is excellent, and the score of 50 or less means that the herbicidal effect is insufficient for a practical use.

### Effect Test 1

A plastic pot with a diameter of 24 cm and a depth of 21 cm was filled with a farmland soil. Each given amount of formulations prepared in Formulation examples 1 and 2 and Comparison examples 1 and 2 is diluted with water. The resulting diluted liquid was sprayed uniformly on the surface of soil with a compact sprayer. The applied dose listed in Table 1 is represented as the amount of the applied flumioxazin.

After spraying the diluted liquid, the pots were placed in a greenhouse whose temperature is 25° C. in the daytime and 20° C. in the nighttime. At the 10th week after the treatment of the diluted liquid, about 50 seeds of Amaranthus retroflexus were seeded. 14 days after the seeding of Amaranthus retroflexus, the herbicidal effect was evaluated.

The results are shown in Table 1.

TABLE 1

| | Applied dose | |
|---|---|---|
| | [g of flumioxazin/ | Herbicidal |
| | 10000 m²] | effect |
| Formulation example 1 | 70 | 96 |
| Formulation example 2 | 70 | 96 |
| Comparison example 1 | 70 | 37 |
| Comparison example 2 | 70 | 7 |

### Effect Test 2

A plastic pot with a diameter of 21 cm and a depth of 17 cm was filled with a farmland soil. Each given amount of formulations prepared in Formulation examples 1 and 2 and Comparison example 1 is diluted with water. The resulting diluted liquid was sprayed uniformly on the surface of soil with a compact sprayer. The applied dose listed in Table 2 is represented as the amount of the applied flumioxazin. After spraying the diluted liquid, the pots were placed outside the room. At the 9th week after the treatment of the diluted liquid, about 50 seeds of Amaranthus retroflexus were seeded. 14 days after the seeding of Amaranthus retroflexus, the herbicidal effect was evaluated.

The results are shown in Table 2.

TABLE 2

| | Applied dose | |
|---|---|---|
| | [g of flumioxazin/ | Herbicidal |
| | 10000 m²] | effect |
| Formulation example 1 | 70 | 96 |
| Formulation example 2 | 70 | 77 |
| Comparison example 1 | 70 | 57 |

1. A herbicide composition comprising N-(7-fluoro-3,4-dihydro-3-oxo-4-prop-2-ynyl-2H-1,4-benzoxazin-6-yl)cyclohex-1-ene-1,2-dicarboxamide and an inert carrier, wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 1.7 μm or less.

2. The herbicide composition according to claim 1 wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 0.1 μm to 1.7 μm.

3. The herbicide composition according to claim 1 wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 0.2 μm to 1.7 μm.

4. The herbicide composition according to claim 1 wherein the N-(7-fluoro-3,4-dihydro-3-oxo-4-prop-2-ynyl-2H-1,4-benzoxazin-6-yl)cyclohex-1-ene-1,2-dicarboxamide has a volume median diameter of 0.25 μm to 1.7 μm.

5. A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 1.7 μm or less to weeds or a soil on which weeds grow.

6. A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 0.1 μm to 1.7 μm to weeds or a soil on which weeds grow.

7. A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 0.2 μm to 1.7 μm to weeds or a soil on which weeds grow.

8. A method for controlling weeds which comprises applying an effective amount of N-(7-fluoro-3,4-dihydro-3-oxo-4-prop-2-ynyl-2H-1,4-benzoxazin-6-yl)cyclohex-1-ene-1,2-dicarboxamide having a volume median diameter of 0.25 μm to 1.7 μm to weeds or a soil on which weeds grow.
